(19) United States
(12) Patent Application Publication
(10) Pub. No.: US 2021/0270113 A1
(43) Pub. Date: Sep. 2, 2021

(54) Calibrating A Geomodel Using Fracture-To-Fracture Interactions

(71) Applicant: W. D. Von Gonten Laboratories, LLC, Houston, TX (US)

(72) Inventors: Javad Sovizi, Houston, TX (US); Egor Dontsov, Houston, TX (US); Roberto Suarez-Rivera, Houston, TX (US)

(21) Appl. No.: 17/190,130

(22) Filed: Mar. 2, 2021

Related U.S. Application Data
(60) Provisional application No. 62/984,021, filed on Mar. 2, 2020.

(51) Int. Cl. E21B 43/26; E21B 47/06; G01V 99/00

(52) U.S. Cl. CPC E21B 43/26; G01V 2210/646; G01V 99/005; E21B 47/06

(57) ABSTRACT

A method comprising calibrating a geomodel by comparing data indicative of fracture-to-fracture interactions from a completed multi-stage hydraulic fracturing process to data from a simulated multi-stage hydraulic fracturing process. In particular, the method includes comparing a simulated instantaneous shut-in pressure and a simulated wellhead pressure to a measured instantaneous shut-in pressure and a measured wellhead pressure. Based on this comparison, one or more properties of the geomodel are adjusted and the multi-stage hydraulic fracturing process is re-simulated until the simulated values are substantially equivalent to the measured values.

### CROSS-REFERENCE TO RELATED APPLICATIONS

This application claims the benefit of U.S. patent application Ser. No. 62/984,021, filed Mar. 2, 2020 and incorporated herein by reference.

### BACKGROUND

Geomodels are used in the oil and gas industry to evaluate and predict the amount and quality of hydrocarbons that can be recovered from a selected reservoir. Typical geomodels include data representing the rock type, stress, porosity, permeability, and fluid stored within a certain volume. Data can be extracted from geomodels to support the simulation of processes including the drilling and completion of wells as well as the production from and behavior of the reservoir as hydrocarbons are produced.

As geomodels are often constructed using incomplete data it is known and accepted that the geomodel is not a wholly accurate reflection of the subject area. Thus, it is often desirable to calibrate the geomodel by comparing the behavior predicted using the geomodel with actual data taken from field operations and adjusting the geomodel so that the simulations more closely match actual field data. This process is known as history matching.

Pressure history matching of field hydraulic fracture treatments with numerical simulators of the field treatment has been the standard way of comparing and calibrating modeled treatment results with field treatment measurements. These comparisons have traditionally been done by comparing the real and simulated treatment pressures of a single well, with adequately spaced fractures, and selecting representative stages in this well (1 to 5), to reduce the computational time and effort.

If the fractures are sufficiently spaced between one another, their interaction is minimal and their behavior can be considered independent to one another. If the latter is the case, any arbitrary stage along the lateral well can be used to calibrate the model and the calibrated results should apply to all stages. This method has worked in the past for all conventional completions and the early unconventional completions designs. However, the industry's new concepts of developing fields by drilling multiple, closely-spaced, wells, and then completing these wells using tightly spaced clusters that are stimulated sequentially (i.e., zipper fracturing), has imposed important challenges to the traditional procedure for pressure history matching.

For example, multiple (e.g., 4 to 10) wells with multiple (40 to 70) stages/clusters per well are stimulated following a particular stimulation sequence. The tight cluster spacing may result in strong fracture-to-fracture interactions. More specifically, a fracture that is generated in a particular well, at a particular time, can affect a fracture generated in a subsequent well due to the specific completion sequence used. These fracture-to-fracture interactions, or stress shadow, result from induced local stresses that develop around fractures dependent on their geometry and dimensions.

In general, as wells are placed in close proximity to one another, the stages and fracture clusters of those completed wells also tend to be spaced in close proximity. As the size of the fractures becomes larger the larger the stress shadow that develops between adjacent fractures, and the stronger their interaction between those fractures. Because fracture propagation will follow the path of least resistance, the stress shadow from previous fractures can alter the propagation of later fractures.

This means that even under the same conditions of fracture design and well configuration, changing the fracture sequence configuration will change the local stress development and therefore change the geometries of the fractures and the pressure responses of each fracture during the stimulation treatment. As a result, for multi-well, multi-stage stimulation treatments, when comparing a numerical simulation with field measurements, each and every stage must be considered, and considered in the same fracture sequencing order. One can no longer select specific stages and ignore the others, as it was the case in the conventional method.

Further, the pressure response that one seeks to match, to demonstrate the validity of the numerical model to the field response, is primarily the induced stress or stress shadow that develop between fractures, through all stages and all wells. These induced stresses are particularly sensitive to the rock properties, the in-situ stress, the fluid leakoff at the time when pressure measurements are taken, and the particular fracture sequence used. Therefore, they are particularly sensitive to the geomodel properties. This is in contrast to the conventional method where one seeks to match the treatment pressure of every stage (which are strongly dominated by the pipe friction and less strongly dominated by the model properties). An adequate and well calibrated mechanical geomodel should closely simulate the pressure behavior of all the fractures in all the wells simultaneously, without requiring adjustments of model properties at every individual stage.

Thus, there remains a need in the art for methods to calibrate geomodels

The use of high-resolution data in modeling can be challenging due to the amount of data required, both in the acquisition of the data and in the computation time required to run simulations on high resolution data. These challenges are particularly present when attempting to simulate hydraulic fracturing of multiple wells in regional-scale models that aim to represent variability of rock properties in a three-dimensional space.

### BRIEF DESCRIPTION OF THE DRAWINGS

For a more detailed description of the embodiments of the disclosure, reference will now be made to the accompanying drawings, wherein:

FIG. 1 illustrates the change in wellhead pressure during a completion operation.

FIGS. 2A and 2B are graphical representations of simulated and measured wellhead pressure for a multi-well, multi-stage completion.

### DETAILED DESCRIPTION

It is to be understood that the following disclosure describes several exemplary embodiments for implementing different features, structures, or functions of the invention. Exemplary embodiments of components, arrangements, and configurations are described below to simplify the disclosure; however, these exemplary embodiments are provided merely as examples and are not intended to limit the scope of the invention. Additionally, the disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Finally, the exemplary embodiments presented below may be combined in any combination of ways, i.e., any element from one exemplary embodiment may be used in any other exemplary embodiment, without departing from the scope of the disclosure.

All numerical values in this disclosure may be exact or approximate values unless otherwise specifically stated. Accordingly, various embodiments of the disclosure may deviate from the numbers, values, and ranges disclosed herein without departing from the intended scope. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following discussion and in the claims, the terms “including” and “comprising” are used in an open-ended fashion, and thus should be interpreted to mean “including, but not limited to.” Furthermore, as it is used in the claims or specification, the term “or” is intended to encompass both exclusive and inclusive cases, i.e., “A or B” is intended to be synonymous with “at least one of A and B,” unless otherwise expressly specified herein.

Certain terms are throughout the following description and claims refer to particular components. As one having ordinary skill in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function.

The methods described herein include conducting ultra-fast simulations of multi-well, multi-stage hydraulic fractures in order to ascertain how well actual field results match simulated results using a particular geomodel. A comparison of the actual and simulated pressure interactions between the fractures (induced stresses or stress shadow) can be used to adjust the global geomodel properties so as to minimize the differences across all wells and all stages simultaneously and calibrate the geomodel.

Once a geomodel is calibrated based on actual data from one multi-well pad, it can be applied to other multi-well pads in the same area of interest (i.e., and adjacent segment of the larger model). For this case, the resulting predictions are calibrated to the large model behavior, but local differences observed between the model predictions and the field measurements can be used to identify local heterogeneities of features that are not represented in the larger model (e.g., natural fractures, faults, local heterogeneities in material properties, pore pressure, or others). The analysis thus also may provide a prediction of the local feature types (e.g., natural fractures, faults, local heterogeneities in material properties, pore pressure, or others), their location along the lateral wellbore, and the magnitude of their effect on the measured fracture features (wellhead pressure, ISIP, and others).

Thus, the methods described herein provide a practical, convenient, ultra-fast, and automatic way for comparing the fracture-to-fracture interactions, or stress shadow, from a numerical model to the field treatment measurements and the calibrating the model by changing model bulk (global) properties to minimize the differences between the two. The methods described herein can also be used to compare a geomodel model that has been previously calibrated globally (i.e., by modifying properties over the entire model) and applied to another nearby region, in a nearby area representative of the previous (the same area of interest) to define local differences. The local differences between the predictions and actual measurements can be identified by their position, the type of influence observed, and their magnitude, and used to infer the type of feature present at that location (faults, rock property heterogeneities, frack hits from another wells, etc), which was not represented in the global model

In certain embodiments, a pre-calibrated model could be obtained by conducting a calibration with a data set from a multi-well pad that has been previously stimulated, which, after calibration, could then be applied to an adjacent multi-well pad. Alternatively, the model could be calibrated by using an initial number of stages in the same well pad being stimulated (e.g., the first 10 stages from each well) and subsequently, after calibration, use the calibrated model to predict all the subsequent stages of the same pad.

The first step in calibrating a geomodel is gathering design information about a completed hydraulic fracturing process, including information on well trajectories, perforation, cluster and stage configuration for each well, including the pumping schedule with field measured fluid and proppant properties, and fracture sequencing order. During the hydraulic fracturing process field data is obtained including the exact pumping conditions, well sequence, pressures, and time between fractures. In certain embodiments, this field data may be gathered in real time from an onsite data feed. The collected field data can be processed from each stage and each well, to extract fracture features such as well-head pressure, instantaneous shut-in pressure (ISIP) at multiple times, leak-off parameters, water hammer properties, and other time and pressure data.

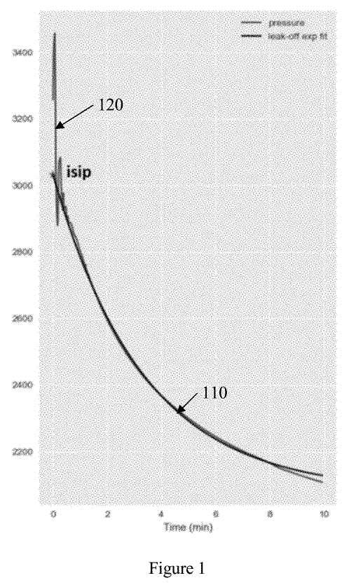

In certain embodiments, if post shut-in pressure data is recorded for sufficiently long time (typically more than 2 minutes), an exponential function may be fit to the portion of pressure data after the water hammer effect dissipates. A consistent ISIP value can be calculated by extrapolating a fitted exponential curve 110 to the shut-in time 120 (as shown in FIG. 1). If post shut-in recorded pressure data is recorded for a shorter amount of time (less than 2 minutes) an exponential curve can be fit to the pressure data with a decaying harmonic to the water hammer data and the exponential portion of the combined fit curve can be used to calculate the ISIP value. ISIP values can then be calculated for every stage and every well that was hydraulically fractured.

The design information of the hydraulic fracturing process can then be used as inputs to hydraulic fracture simulation software that simulates the fracturing process into a selected geomodel. The simulation software can generate the predicted evolution of the fracture features versus stage number or time, which can be compared against the corresponding information extracted from the field data.

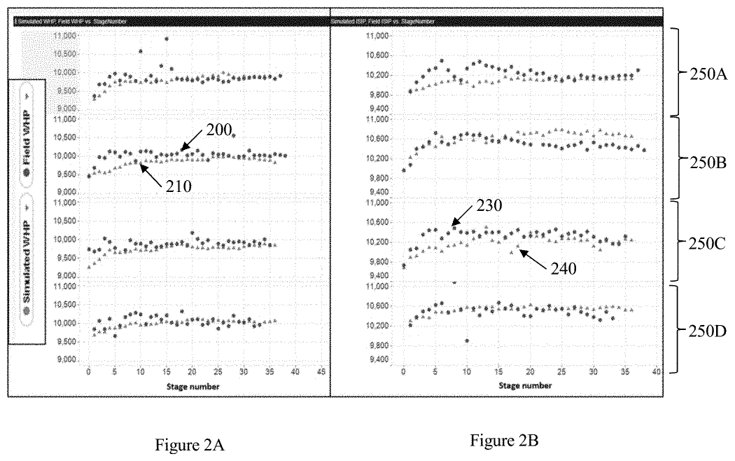

As shown in FIGS. 2A and 2B, the measured ISIP and wellhead pressure compared to simulated ISIP and wellhead pressure for each stage of a multi-well completion. In particular FIG. 2A illustrates field wellhead pressure data 200 compared to simulated wellhead pressure data 210 and FIG. 2B illustrates field ISIP data 220 compared to simulated ISIP data 230. The compared data is shown for each stage 240 and on four wells 250A-250D, each of which are completed as part of the same process.

The ISIP and well-head pressure from stage to stage and well to well, represent the change in magnitude of the stress shadow in the region where each fracture developed. If there is no change in these values from stage to stage, there is no interaction between fractures from stage to stage. Conversely, if these values change abruptly and monotonically on each subsequent stage, this change is an indication of strong stress interactions during fracturing (closely spaced wells, large fractures, strong containment to height growth, and others). The evolution of these fracture properties, for a given pump schedule and well configuration, is controlled by the geomodel properties (primarily the in-situ stress, leak-off, and the number of fractures that develop per stage).

The geomodel can be calibrated by first adjusting the in-situ stress by changing the horizontal tectonic strain globally, in the geomodel, while using the leak off profile originally proposed in the geomodel, to best match the initial state of the field fracture features (ISIP, WHP, others), for all stages in all wells, simultaneously (i.e., use only the first stage data for each well). Next, adjustments can be made to the leak-off multiplier and secondarily the global tectonic strain of the geomodel, to best match the early time-evolution of the field fracture features (ISIP, WHP, others), for all stages in all wells, simultaneously. The early time evolution of the fracture features provides a strong indication of the magnitude of the stress shadow between wells. The early time is defined as the number of stages or time it takes to reach an onset of stress shadow saturation, where the latter is characterized by a relatively small changes in ISIP.

Once the values of tectonic strain and leak-off in the regional geomechanical model are calibrated, the geomodel can be used for conducting numerical simulations on subsequent multi-well pads in the same region. In certain embodiments, the calibrated geomodel can be used to conduct base-line simulations ahead of any stage fractures in the multi-well pad. During hydraulic fracturing treatments, real-time pressure data can be received and processed so that the real-time treatment data and the model-predicted pressure data simultaneously. This allows an evaluation of the relationship between the actual data and simulated data and, in particular, a visualization of the evolution of the fracture features from stage to stage, which are strongly controlled by the fracture-to-fracture stress interactions.

In certain embodiments, an ultra-fast hydraulic fracture simulator can be used to evaluate the evolution of the local, fracture-level, stress from one stage to the next one, given the current state of stress and the fracturing completion input (e.g., slurry rate and proppant concentration). The prediction of the stress shadow for the subsequent stage has an uncertainty that is inherent in the measured data and could be adjusted based on the level of confidence one has on the geomechanical geomodel model. If the model has been previously calibrated, its uncertainty is low. As fracturing proceeds, the ultra-fast hydraulic fracture simulator can be used to perform regularized re-calibration with respect to regionally variant parameters (e.g., tectonic strain and leak off coefficients) or to investigate the possible deviation of base-line simulation from measured field data. As the number of completed stages increases, the re-calibrated parameters are expected to become more accurate. The differences between the globally calibrated model and the stage by stage field data and the local changes that are required for matching these differences can also provide a prediction of the type of local features that could be causing these variations (e.g., natural fractures, faults, local rock heterogeneity distributions, others) and local geomodel information that was not present in the global geomodel.

Thus, the methods described herein provide a unique way of comparing and calibrating geomechanical models used for multi-well, multi-stage zipper fracturing simulations, based on stress shadow matching as opposed to the traditional pressure history matching workflows which compare treatment pressures. These methods allow for the improved analysis of multi-well, multi-stage zipper fracturing treatments that tend to develop strong fracture-to fracture interactions (stress shadow) which are highly sensitive to the model properties (e.g., in-situ stress, reservoir pressure, rock properties, leak-off).

While the disclosure is susceptible to various modifications and alternative forms, specific embodiments thereof are shown by way of example in the drawings and description. It should be understood, however, that the drawings and detailed description thereto are not intended to limit the claims to the particular form disclosed, but on the contrary, the intention is to cover all modifications, equivalents, and alternatives falling within the scope of the claims.

What is claimed is:

1. A method comprising:
(A) constructing a geomodel representing the formation having one or more wells drilled therein;
(B) collecting data from a completed multi-stage hydraulic fracturing process in the one or more wells, wherein the collected data includes design information and field data;
(C) determining a measured ISIP and a measured wellhead pressure for each stage of the multi-stage hydraulic fracturing process;
(D) simulating the multi-stage hydraulic fracturing process using the geomodel and the design information of the multi-stage hydraulic fracturing process to obtain a simulated ISIP and a simulated wellhead pressure for each stage of the multi-stage hydraulic fracturing process;
(E) comparing the simulated ISIP and the simulated wellhead pressure from each stage of the multi-stage hydraulic fracturing process to the corresponding measured ISIP and measured wellhead pressure from each stage of the multi-stage hydraulic fracturing process;
(F) adjusting a property of the geomodel;
(G) repeating steps D through F until the simulated ISIP and the simulated wellhead pressure from each stage of the multi-stage hydraulic fracturing process are substantially equivalent to the measured ISIP and the measured wellhead pressure from each stage of the multi-stage hydraulic fracturing process; and
(H) using the geomodel with adjusted properties to simulate a second multi-stage hydraulic fracturing process in the formation.

2. The method of claim 1, wherein adjusting the property of the geomodel further comprises adjusting an in-situ stress by changing horizontal tectonic strain.

3. The method of claim 1, wherein adjusting the property of the geomodel further comprises adjusting a leak-off multiplier and a global tectonic strain.

4. The method of claim 1, wherein the design information includes a well trajectory, perforation, cluster and stage configuration for a well, pumping schedule, fluid and proppant properties, and fracture sequencing order.

5. The method of claim 1, wherein field data includes pumping sequence and pressure within the well over time.

6. The method of claim 1, wherein the measured ISIP is determined by extrapolating a fitted exponential curve to a measured pressure.

7. The method of claim 1, wherein the multi-stage hydraulic fracturing process is simulated using a hydraulic fracture simulation program that uses the geomodel and the design data to predict the behavior of the formation during the multi-stage hydraulic fracturing process.

8. A method comprising:
collecting field data from a multi-stage hydraulic fracturing process performed within a wellbore disposed in a formation;
determining a measured ISIP and a measured wellhead pressure for each stage of the multi-stage hydraulic fracturing process;
determining a simulated ISIP and a simulated wellhead pressure for each stage of the multi-stage hydraulic fracturing process using hydraulic fracture simulation software, wherein a geomodel of the formation and design data of the multi-stage hydraulic fracturing process are used as inputs to the hydraulic fracture simulation software;
comparing the simulated ISIP and the simulated wellhead pressure from each stage of the multi-stage hydraulic fracturing process to the corresponding measured ISIP and measured wellhead pressure from each stage of the multi-stage hydraulic fracturing process;
comparing the simulated ISIP and the simulated wellhead pressure from each stage of the multi-stage hydraulic fracturing process to the corresponding measured ISIP and measured wellhead pressure from each stage of the multi-stage hydraulic fracturing process;
adjusting one or more properties of the geomodel and determining an adjusted ISIP and adjusted wellhead pressure until the adjusted ISIP and adjusted wellhead pressure are substantially equivalent to the measured ISIP and the measured wellhead pressure from each stage of the multi-stage hydraulic fracturing process; and
using the geomodel with the one or more adjusted properties to simulate a second multi-stage hydraulic fracturing process in the formation.

9. The method of claim 8, wherein adjusting the property of the geomodel further comprises adjusting an in-situ stress by changing horizontal tectonic strain.

10. The method of claim 8, wherein adjusting the property of the geomodel further comprises adjusting a leak-off multiplier and a global tectonic strain.

11. The method of claim 8, wherein the design information includes a well trajectory, perforation, cluster and stage configuration for a well, pumping schedule, fluid and proppant properties, and fracture sequencing order.

12. The method of claim 8, wherein field data includes pumping sequence and pressure within the well over time.

13. The method of claim 8, wherein the measured ISIP is determined by extrapolating a fitted exponential curve to a measured pressure over a period of time.

14. A method comprising:
constructing a geomodel representing the formation having one or more wells drilled therein;
collecting data from a completed multi-stage hydraulic fracturing process in the one or more wells, wherein the collected data includes design information and field data;
determining a measured ISIP and a measured wellhead pressure from the field data collected from each stage of the multi-stage hydraulic fracturing process;
simulating the multi-stage hydraulic fracturing process using the geomodel and the design information of the multi-stage hydraulic fracturing process to obtain a simulated ISIP and a simulated wellhead pressure from each stage of the multi-stage hydraulic fracturing process;
calibrating the geomodel by comparing the simulated ISIP and simulated wellhead pressure to the measured ISIP and measured wellhead pressure, adjusting one or more properties of the geomodel, and re-simulating the multi-stage hydraulic fracturing process until the simulated ISIP and simulated wellhead pressure are substantially equivalent to the measured ISIP and measured wellhead pressure;
using the calibrated geomodel to simulate a second multi-stage hydraulic fracturing process in the formation.

15. The method of claim 14, wherein the one or more properties of the geomodel includes horizontal tectonic strain.

16. The method of claim 14, wherein the one or more properties of the geomodel includes a leak-off multiplier.

17. The method of claim 14, wherein the design information includes a well trajectory, perforation, cluster and stage configuration for a well, pumping schedule, fluid and proppant properties, and fracture sequencing order.

18. The method of claim 14, wherein field data includes pumping sequence and pressure within the well over time.

19. The method of claim 14, wherein the measured ISIP is determined by extrapolating a fitted exponential curve to a measured pressure within the well over a period of time.

20. The method of claim 14, wherein the multi-stage hydraulic fracturing process is simulated using a hydraulic fracture simulation program that uses the geomodel and the design data to predict the behavior of the formation during the multi-stage hydraulic fracturing process.
